(19) United States
(12) Patent Application Publication
(10) Pub. No.: US 2019/0097328 A1
(43) Pub. Date: Mar. 28, 2019

(54) Systems and Methods for Mitigating Polarization Loss

(71) Applicant: Apple Inc., Cupertino, CA (US)

(72) Inventors: Siwen Yong, San Francisco, CA (US); Yi Jiang, Cupertino, CA (US); Jiangfeng Wu, San Jose, CA (US); Lijun Zhang, San Jose, CA (US); Mattia Pascolini, San Francisco, CA (US)

(21) Appl. No.: 15/714,970

(22) Filed: Sep. 25, 2017

(51) Int. Cl. H01Q 21/24; H01Q 5/35; H01Q 9/04; H04B 7/06; H04W 40/12; H01Q 3/24; H01Q 3/26; H04L 1/00

(52) U.S. Cl. CPC H01Q 21/245; H01Q 5/35; H01Q 9/0407; H04L 1/0015; H04W 40/12; H01Q 3/24; H01Q 3/26; H04B 7/0608

(57) ABSTRACT

An electronic device may be provided with wireless communications circuitry and control circuitry. The wireless communications circuitry may include centimeter wave and millimeter wave transceiver circuitry and a phased antenna array. The phased antenna array may transmit and receive wireless signals having a frequency higher than 10 GHz. Beam steering circuitry may be coupled to the phased antenna array and may be adjusted to steer the wireless signals to communicate with external equipment. Sensor circuitry in the electronic device may gather sensor data. The control circuitry may use the gathered sensor data to determine a polarization mismatch between the electronic device and the external equipment (e.g., between a signal transmitting device and a signal receiving equipment or vice versa). To mitigate the polarization mismatch data loss, the control circuitry may adjust the polarization settings associated with antennas of the electronic device.

### BACKGROUND

This relates generally to electronic devices and, more particularly, to electronic devices with wireless communications circuitry.

Electronic devices often include wireless communications circuitry. For example, cellular telephones, computers, and other devices often contain antennas and wireless transceivers for supporting wireless communications.

It may be desirable to support wireless communications in millimeter wave and centimeter wave communications bands. Millimeter wave communications, which are sometimes referred to as extremely high frequency (EHF) communications, and centimeter wave communications involve communications at frequencies of about 10-300 GHz. Operation at these frequencies may support high bandwidths, but may raise significant challenges. For example, millimeter wave communications often involve polarization mismatch between transmitting and receiving devices that can be characterized by substantial attenuation during signal reception.

It would therefore be desirable to be able to provide electronic devices with improved wireless communications circuitry such as communications circuitry that supports millimeter wave communications.

### SUMMARY

An electronic device may be provided with wireless circuitry. The wireless circuitry may include one or more antennas and transceiver circuitry such as centimeter and millimeter wave transceiver circuitry (e.g., circuitry that transmits and receives antennas signals at frequencies greater than 10 GHz). The electronic device may include one or more antenna elements. The antenna elements may be arranged one or more phased antenna arrays. The phased antenna array may transmit and receive a beam of wireless signals to communicate with external equipment (e.g., an external device). Beam steering circuitry coupled to the phased antenna array may be adjusted to steer a direction of the beam.

Control circuitry in the electronic device may be coupled to the phased antenna array. The control circuitry may be configured to identify a polarization mismatch between the phased antenna array and the external equipment and to selectively adjust a signal polarization setting of the phased antenna array based on the identified polarization mismatch. The electronic device may include sensor circuitry that generates sensor data. The sensor data may be used to identify whether there is an acceptable amount of polarization mismatch between the phased antenna array and the external equipment. In particular, the sensor data (e.g., a sensor value) may be compared to a range of acceptable sensor data values (e.g., defined by one or more threshold values). In response to determining that the sensor data is outside of the range, the control circuitry may adjust the polarization setting of the phased antenna array from a first polarization setting to a second polarization setting.

As an example, the phased antenna array may include a plurality of patch antenna elements that each have a first antenna feed coupled to the beam steering circuitry. The plurality of patch antenna elements may each also have a second antenna feed coupled to the beam steering circuitry. The plurality of patch antenna elements may receive different sets of phase and magnitude values that change the signal polarization setting of the phased antenna array based on the gathered sensor data. In this way, the electronic device may perform wireless communications with the external equipment while mitigating polarization mismatch data loss between the electronic device and the external equipment.

### BRIEF DESCRIPTION OF THE DRAWINGS

FIG. 1 is a diagram of a wireless system having first and second illustrative electronic devices that may communicate via communication links in accordance with an embodiment.

FIG. 2 is a schematic diagram of an illustrative electronic device with wireless communications circuitry in accordance with an embodiment.

FIG. 3 is a diagram of an illustrative phased antenna array that may be adjusted using control circuitry to direct a beam of signals in accordance with an embodiment.

FIG. 4 is a perspective view of an illustrative patch antenna in accordance with an embodiment.

FIG. 5 is a perspective view of an illustrative patch antenna with dual ports in accordance with an embodiment.

FIGS. 6A and 6B are diagrams of an illustrative electronic device that may adjust polarization settings to mitigate polarization loss in accordance with an embodiment.

FIG. 7 is a diagram of a wireless system having first and second illustrative electronic devices that may both re-align polarization settings to enhance antenna performance in accordance with an embodiment.

FIG. 8 is a flow chart of illustrative steps that may be performed by a pair of electronic devices to mitigate polarization loss and enhance antenna channel efficiency in accordance with an embodiment.

### DETAILED DESCRIPTION

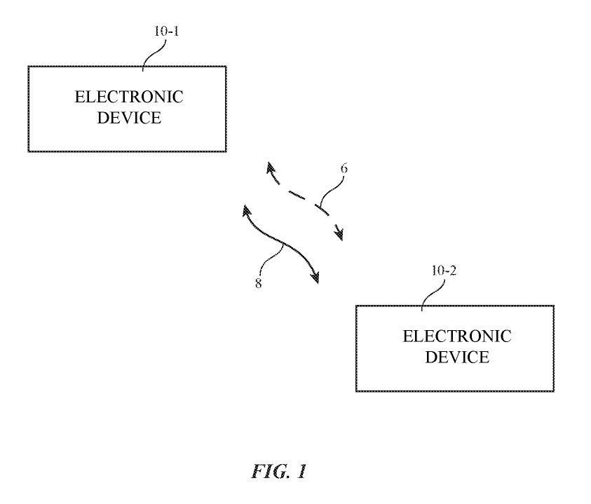

Electronic devices such as electronic devices 10-1 and 10-2 of FIG. 1 may contain wireless circuitry. The wireless circuitry may include one or more antennas. The antennas may include phased antenna arrays that are used for handling millimeter wave and centimeter wave communications. Millimeter wave communications, which are sometimes referred to as extremely high frequency (EHF) communications, involve signals at 60 GHz or other frequencies between about 30 GHz and 300 GHz. Centimeter wave communications involve signals at frequencies between about 10 GHz and 30 GHz. While uses of millimeter wave communications may be described herein as examples, centimeter wave communications, EHF communications, or any other types of communications may be similarly used. If desired, devices 10-1 and/or 10-2 may also contain wireless communications circuitry for handling satellite navigation system signals, cellular telephone signals, local wireless area network signals, near-field communications, light-based wireless communications, or other wireless communications.

Electronic device 10-1 may be a computing device such as a laptop computer, a computer monitor containing an embedded computer, a tablet computer, a cellular telephone, a media player, or other handheld or portable electronic device, a smaller device such as a wristwatch device, a pendant device, a headphone or earpiece device, a virtual or augmented reality headset device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless access point or base station (e.g., a wireless router or other equipment for routing communications between other wireless devices and a larger network such as the internet or a cellular telephone network), a desktop computer, a keyboard, a gaming controller, a computer mouse, a mousepad, a trackpad or touchpad, equipment that implements the functionality of two or more of these devices, or other electronic equipment.

Electronic device 10-2 may sometimes be referred to herein as external device 10-2 or external equipment 10-2. External device 10-2 may be the same type of device as device 10-1 or may be a different type of device. Other configurations may be used for devices 10-1 and 10-2 if desired. For example, external device 10-2 may be a separate and distinct device from device 10-1 (e.g., external device 10-2 may include a respective housing that is separate from the housing of device 10-1, may include separate processing and input-output circuitry, etc.). In general, external device 10-2 may include any desired wireless communications circuitry that is separate from (e.g., external to) electronic device 10-1. The components of external device 10-2 need not be enclosed within a corresponding electronic device housing in some scenarios. If desired, external device 10-2 may be an accessory to device 10-1 or device 10-1 may be an accessory device to external device 10-2 (e.g., an accessory such as a remote control that provides data to device 10-1 and/or receives data from device 10-1, a wireless speaker that plays audio data generated by device 10-1, wireless headset, a wireless keyboard, wireless trackpad, wireless mouse, etc.).

In general, external device 10-2 may be a computing device such as a laptop computer, a computer monitor containing an embedded computer, a tablet computer, a cellular telephone, a media player, or other handheld or portable electronic device, a smaller device such as a wristwatch device, a pendant device, a headphone or earpiece device, a virtual or augmented reality headset device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless access point or base station (e.g., a wireless router or other equipment for routing communications between other wireless devices and a larger network such as the internet or a cellular telephone network), a desktop computer, a keyboard, a gaming controller, a computer mouse, a mousepad, a trackpad or touchpad, equipment that implements the functionality of two or more of these devices, or other electronic equipment having wireless communications capabilities.

Wireless circuitry on electronic device 10-1 may perform wireless communications with wireless circuitry on external equipment such as electronic device 10-2. As shown in FIG. 1, wireless circuitry on electronic device 10-1 may perform centimeter and millimeter wave communications with wireless circuitry on electronic device 10-2 over a wireless centimeter and millimeter wave link such as communications link 8. Communications link 8 may be, for example, a wireless bidirectional link over which data is conveyed from electronic device 10-1 to electronic device 10-2 and from electronic device 10-2 to electronic device 10-1 (e.g., at one or more centimeter or millimeter wave frequencies). This is merely illustrative and, in another arrangement, communications link 8 may be unidirectional.

If desired, wireless circuitry on electronic device 10-1 may perform wireless communications with external equipment such as electronic device 10-2 over a non-centimeter/millimeter wave link such as optional wireless link 6 (sometimes referred to herein as non-millimeter wave communications link 6 or out-of-band link 6). Wireless link 6 may be, for example, a wireless local area network (WLAN) link such as a Wi-Fi® link or a wireless personal area network (WPAN) link such as a Bluetooth® link. Link 6 may be bidirectional or unidirectional. In general, data conveyed over link 6 may be conveyed over any desired non-centimeter/millimeter wave communications band (e.g., a communications band at frequencies less than 10 GHz). Data may be conveyed over link 8 at a higher bandwidth than data conveyed over link 6, for example (e.g., because link 8 is maintained at higher frequencies than link 6). This example is merely illustrative. In another suitable arrangement, link 6 may be formed using a wired (conductive) path. In yet another suitable arrangement, link 6 may be maintained over an intervening network such as the Internet (e.g., link 6 may pass through intervening network devices such as network switches and routers). Communications link 6 may be omitted if desired.

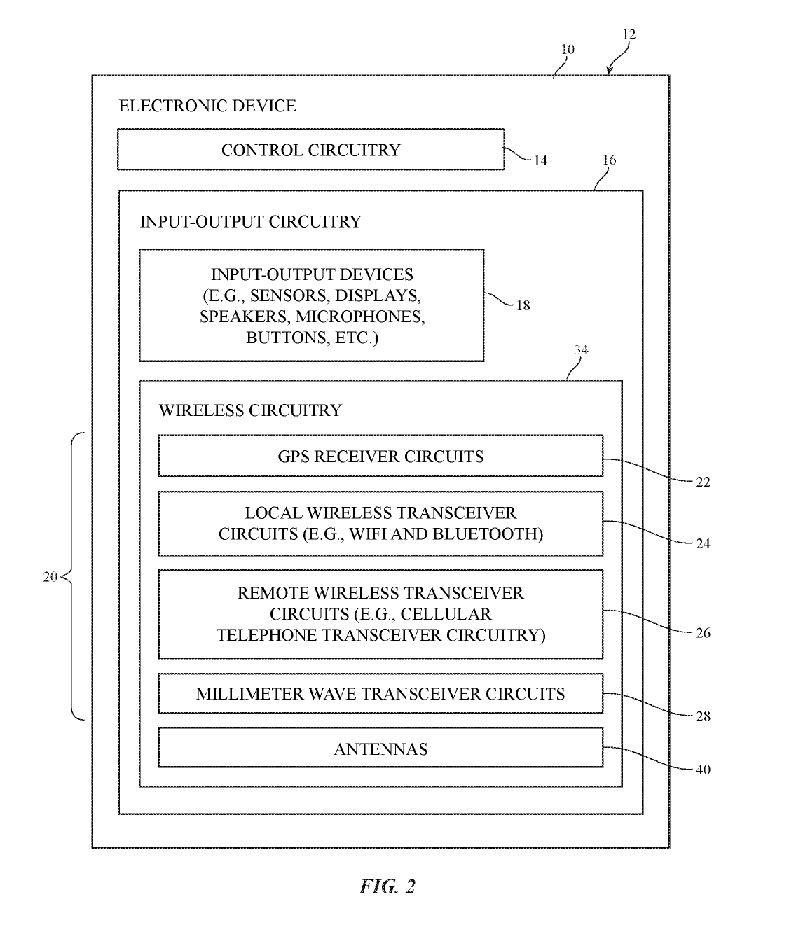

A schematic diagram showing illustrative components that may be used in an electronic device such as electronic devices 10-1 and/or 10-2 of FIG. 1 is shown in FIG. 2. As shown in FIG. 2, device 10 (e.g., electronic device 10-1 and/or electronic device 10-2 of FIG. 1) may include storage and processing circuitry such as control circuitry 14. Control circuitry 14 may include storage such as hard disk drive storage, nonvolatile memory (e.g., flash memory or other electrically-programmable-read-only memory configured to form a solid-state drive), volatile memory (e.g., static or dynamic random-access-memory), etc. Processing circuitry in control circuitry 14 may be used to control the operation of device 10. This processing circuitry may be based on one or more microprocessors, microcontrollers, digital signal processors, baseband processor integrated circuits, application specific integrated circuits, etc.

Control circuitry 14 may be used to run software on device 10, such as internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network protocols (e.g., IEEE 802.11 protocols—sometimes referred to as WiFi®), protocols for other short-range wireless communications links such as the Bluetooth® protocol or other WPAN protocols, IEEE 802.11ad protocols, cellular telephone protocols, MIMO protocols, antenna diversity protocols, satellite navigation system protocols, etc.

Device 10 may include input-output circuitry 16. Input-output circuitry 16 may include input-output devices 18. Input-output devices 18 may be used to allow data to be supplied to device 10 and to allow data to be provided from device 10 to external devices. Input-output devices 18 may include user interface devices, data port devices, and other input-output components. For example, input-output devices may include touch screens, displays without touch sensor capabilities, buttons, joysticks, scrolling wheels, touch pads, key pads, keyboards, microphones, cameras, image sensors, speakers, status indicators, light sources, audio jacks and other audio port components, digital data port devices, light sensors, accelerometers or other components that can detect motion and device orientation relative to the Earth, capacitance sensors, proximity sensors (e.g., a capacitive proximity sensor and/or an infrared proximity sensor), magnetic sensors, and other sensors and input-output components.

Input-output circuitry 16 may include wireless communications circuitry 34 for communicating wirelessly with external equipment. Wireless communications circuitry 34 may include radio-frequency (RF) transceiver circuitry formed from one or more integrated circuits, power amplifier circuitry, low-noise input amplifiers, passive RF components, one or more antennas 40, transmission lines, and other circuitry for handling RF wireless signals. Wireless signals can also be sent using light (e.g., using infrared communications).

Wireless communications circuitry 34 may include radio-frequency transceiver circuitry 20 for handling various radio-frequency communications bands. For example, circuitry 34 may include transceiver circuitry 22, 24, 26, and 28.

Transceiver circuitry 24 may be wireless local area network transceiver circuitry. Transceiver circuitry 24 may handle 2.4 GHz and 5 GHz bands for WiFi® (IEEE 802.11) communications and may handle the 2.4 GHz Bluetooth® communications band.

Circuitry 34 may use cellular telephone transceiver circuitry 26 for handling wireless communications in frequency ranges such as a low communications band from 700 to 960 MHz, a midband from 1710 to 2170 MHz, and a high band from 2300 to 2700 MHz or other communications bands between 600 MHz and 4000 MHz or other suitable frequencies (as examples). Circuitry 26 may handle voice data and non-voice data.

Millimeter wave transceiver circuitry 28 (sometimes referred to as extremely high frequency (EHF) transceiver circuitry 28 or transceiver circuitry 28) may support communications at frequencies between about 10 GHz and 300 GHz. For example, transceiver circuitry 28 may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, transceiver circuitry 28 may support communications in an IEEE K communications band between about 18 GHz and 27 GHz, a Kₐ communications band between about 26.5 GHz and 40 GHz, a Ku communications band between about 12 GHz and 18 GHz, a V communications band between about 40 GHz and 75 GHz, a W communications band between about 75 GHz and 110 GHz, or any other desired frequency band between approximately 10 GHz and 300 GHz. If desired, circuitry 28 may support IEEE 802.11ad communications at 60 GHz and/or 5th generation mobile networks or 5th generation wireless systems (5G) communications bands between 27 GHz and 90 GHz. If desired, circuitry 28 may support communications at multiple frequency bands between 10 GHz and 300 GHz such as a first band from 27.5 GHz to 28.5 GHz, a second band from 37 GHz to 41 GHz, and a third band from 57 GHz to 71 GHz, or other communications bands between 10 GHz and 300 GHz. Circuitry 28 may be formed from one or more integrated circuits (e.g., multiple integrated circuits mounted on a common printed circuit in a system-in-package device, one or more integrated circuits mounted on different substrates, etc.). While circuitry 28 is sometimes referred to herein as millimeter wave transceiver circuitry 28, millimeter wave transceiver circuitry 28 may handle communications at any desired communications bands at frequencies between 10 GHz and 300 GHz (e.g., in millimeter wave communications bands, centimeter wave communications bands, etc.).

Wireless communications circuitry 34 may include satellite navigation system circuitry such as Global Positioning System (GPS) receiver circuitry 22 for receiving GPS signals at 1575 MHz or for handling other satellite positioning data (e.g., GLONASS signals at 1609 MHz). Satellite navigation system signals for receiver 22 are received from a constellation of satellites orbiting the earth.

In satellite navigation system links, cellular telephone links, and other long-range links, wireless signals are typically used to convey data over thousands of feet or miles. In WiFi® and Bluetooth® links at 2.4 and 5 GHz and other short-range wireless links, wireless signals are typically used to convey data over tens or hundreds of feet. Extremely high frequency (EHF) wireless transceiver circuitry 28 may convey signals over these short distances that travel between transmitter and receiver over a line-of-sight path. To enhance signal reception for millimeter and centimeter wave communications, phased antenna arrays and beam steering techniques may be used (e.g., schemes in which antenna signal phase and/or magnitude for each antenna in an array is adjusted to perform beam steering). Antenna diversity schemes may also be used to ensure that the antennas that have become blocked or that are otherwise degraded due to the operating environment of device 10 can be switched out of use and higher-performing antennas used in their place.

Wireless communications circuitry 34 can include circuitry for other short-range and long-range wireless links if desired. For example, wireless communications circuitry 34 may include circuitry for receiving television and radio signals, paging system transceivers, near field communications (NFC) circuitry, etc.

Antennas 40 in wireless communications circuitry 34 may be formed using any suitable antenna types. For example, antennas 40 may include antennas with resonating elements that are formed from loop antenna structures, patch antenna structures, inverted-F antenna structures, slot antenna structures, planar inverted-F antenna structures, monopoles, dipoles, helical antenna structures, Yagi (Yagi-Uda) antenna structures, hybrids of these designs, etc. If desired, one or more of antennas 40 may be cavity-backed antennas. Different types of antennas may be used for different bands and combinations of bands. For example, one type of antenna may be used in forming a local wireless link antenna and another type of antenna may be used in forming a remote wireless link antenna. Dedicated antennas may be used for receiving satellite navigation system signals or, if desired, antennas 40 can be configured to receive both satellite navigation system signals and signals for other communications bands (e.g., wireless local area network signals and/or cellular telephone signals). Antennas 40 can include phased antenna arrays for handling millimeter and centimeter wave communications.

As shown in FIG. 2, device 10 may include a housing such as housing 12. Housing 12, which may sometimes be referred to as an enclosure or case, may be formed of plastic, glass, ceramics, fiber composites, metal (e.g., stainless steel, aluminum, metallic coatings on a substrate, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.). Antennas 40 may be mounted in housing 12. Dielectric-filled openings such as plastic-filled openings may be formed in metal portions of housing 12 (e.g., to serve as antenna windows and/or to serve as gaps that separate portions of antennas 40 from each other).

If desired, housing 12 may include a conductive rear surface. The rear surface of housing 12 may lie in a place that is parallel to a display of device 10. In configurations for device 10 in which the rear surface of housing 12 is formed from metal, it may be desirable to form parts of peripheral conductive housing structures as integral portions of the housing structures forming the rear surface of housing 12. For example, a rear housing wall of device 10 may be formed from a planar metal structure, and portions of peripheral housing structures on the sides of housing 12 may be formed as vertically extending integral metal portions of the planar metal structure. Housing structures such as these may, if desired, be machined from a block of metal and/or may include multiple metal pieces that are assembled together to form housing 12. The planar rear wall of housing 12 may have one or more, two or more, or three or more portions. The peripheral housing structures and/or the conductive rear wall of housing 12 may form one or more exterior surfaces of device 10 (e.g., surfaces that are visible to a user of device 10) and/or may be implemented using internal structures that do not form exterior surfaces of device 10 (e.g., conductive housing structures that are not visible to a user of device 10 such as conductive structures that are covered with layers such as thin cosmetic layers, protective coatings, and/or other coating layers that may include dielectric materials such as glass, ceramic, plastic, or other structures that form the exterior surfaces of device 10 and/or serve to hide internal structures from view of the user).

In scenarios where input-output devices 18 include a display, the display may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures. The display may include an array of display pixels formed from liquid crystal display (LCD) components, an array of electrophoretic display pixels, an array of plasma display pixels, an array of organic light-emitting diode display pixels, an array of electrowetting display pixels, or display pixels based on other display technologies. The display may be protected using a display cover layer such as a layer of transparent glass, clear plastic, sapphire, or other transparent dielectric. If desired, some of the antennas 40 (e.g., antenna arrays that may implement beam steering, etc.) may be mounted under an inactive border region of the display. The display may contain an active area with an array of pixels (e.g., a central rectangular portion). Inactive areas of the display are free of pixels and may form borders for the active area. If desired, antennas may also operate through dielectric-filled openings elsewhere in device 10.

Transmission line paths may be used to route antenna signals within device 10. For example, transmission line paths may be used to couple antenna structures 40 to transceiver circuitry 20. Transmission lines in device 10 may include coaxial cable paths (e.g., coaxial probes realized by metal vias), microstrip transmission lines, stripline transmission lines, edge-coupled microstrip transmission lines, edge-coupled stripline transmission lines, waveguide structures for conveying signals at millimeter wave frequencies (e.g., coplanar waveguides, grounded coplanar waveguides, cavity waveguides, etc.), transmission lines formed from combinations of transmission lines of these types, etc.

Transmission lines in device 10 may be integrated into rigid and/or flexible printed circuit boards. In one suitable arrangement, transmission lines in device 10 may also include transmission line conductors (e.g., signal and ground conductors) integrated within multilayer laminated structure (e.g., layers of conductive material such as copper and dielectric material such as resin that are laminated together without intervening adhesive) that may be folded or bent in multiple dimensions (e.g., in two or three dimension) and that maintain its bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive). Filter circuitry, switching circuitry, impedance matching circuitry, and other circuitry may be interposed within the transmission lines, if desired.

Device 10 may contain multiple antennas 40. The antennas may be used together or one of the antennas may be switched into use while other antenna(s) are switched out of use. If desired, control circuitry 14 may be used to select an optimum antenna to use in device 10 in real time and/or to select an optimum setting for adjustable wireless circuitry associated with one or more of antennas 40. Antenna adjustments may be made to tune antennas to perform in desired frequency ranges, to perform beam steering with a phased antenna array, and to otherwise optimize antenna performance. Sensors may be incorporated into antennas 40 to gather sensor data in real time that is used in adjusting antennas 40.

In some configurations, antennas 40 may be arranged in one or more antenna arrays (e.g., phased antenna arrays to implement beam steering functions). For example, the antennas that are used in handling centimeter and millimeter wave signals for extremely high frequency wireless transceiver circuits 28 may be implemented as phased antenna arrays. The radiating elements in a phased antenna array for supporting centimeter and millimeter wave communications may be patch antennas, dipole antennas, or other suitable antenna elements. Transceiver circuitry 28 can be integrated with the phased antenna arrays to form integrated phased antenna array and transceiver circuit modules or packages if desired.

In devices such as handheld devices, the presence of an external object such as the hand of a user or a table or other surface on which a device is resting has a potential to block wireless signals such as millimeter wave signals. In addition, millimeter wave communications typically require a line of sight between antennas 40 and the antennas on an external device. Accordingly, it may be desirable to incorporate multiple phased antenna arrays into device 10, each of which is placed in a different location within or on device 10. With this type of arrangement, an unblocked phased antenna array may be switched into use and, once switched into use, the phased antenna array may use beam steering to optimize wireless performance. Similarly, if a phased antenna array does not face or have a line of sight to an external device, another phased antenna array that has line of sight to the external device may be switched into use and that phased antenna array may use beam steering to optimize wireless performance. Configurations in which antennas from one or more different locations in device 10 are operated together may also be used (e.g., to form a phased antenna array, etc.).

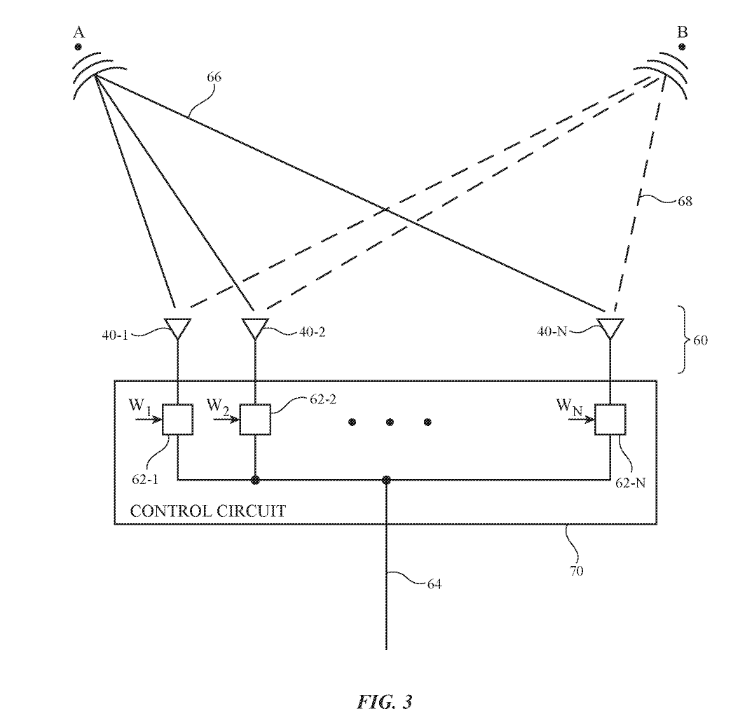

FIG. 3 shows how antennas 40 on device 10 may be formed in a phased antenna array 60. As shown in FIG. 3, phased antenna array 60 (sometimes referred to herein as array 60, antenna array 60, or array 60 of antennas 40) may be coupled to a signal path such as path 64 (e.g., one or more radio-frequency transmission line structures, extremely high frequency waveguide structures or other extremely high frequency transmission line structures, etc.). Array 60 may include a number N of antennas 40 (e.g., a first antenna 40-1, a second antenna 40-2, an Nth antenna 40-N, etc.). Antennas 40 in phased antenna array 60 may be arranged in any desired number of rows and columns or in any other desired pattern (e.g., the antennas need not be arranged in a grid pattern having rows and columns). During signal transmission operations, path 64 may be used to supply signals (e.g., millimeter wave signals) from EHF transceiver circuitry 28 to phased antenna array 60 for wireless transmission to external wireless equipment (e.g., over link 8 of FIG. 1). During signal reception operations, path 64 may be used to convey signals received at phased antenna array 60 from external equipment or devices to transceiver circuitry 28.

The use of multiple antennas 40 in array 60 allows beam steering arrangements to be implemented by controlling the relative phases and amplitudes of the signals for the antennas. In the example of FIG. 3, antennas 40 each have a corresponding radio-frequency phase and magnitude controller 62 (e.g., a first controller 62-1 coupled between signal path 64 and first antenna 40-1, a second controller 62-2 coupled between signal path 64 and second antenna 40-2, an Nth controller 62-N coupled between path 64 and Nth antenna 40-N, etc.). Phase and magnitude controllers 62 may, for example, include phase adjustment circuitry that is controlled to provide a desired phase shift on the signals conveyed by the corresponding antenna 40 and/or gain (magnitude) adjustment circuitry (e.g., adjustable amplifier circuitry) that is controlled (e.g., biased) to provide a desired gain on signals conveyed by the corresponding antenna 40.

Beam steering circuitry such as control circuitry 70 may use phase and magnitude controllers 62 or any other suitable phase and magnitude control circuitry to adjust the relative phases and/or magnitudes of the transmitted signals that are provided to each of the antennas in the antenna array and to adjust the relative phases and/or magnitudes of the received signals that are received by the antenna array from external equipment. The term “beam” or “signal beam” may be used herein to collectively refer to wireless signals that are transmitted and received by array 60 in a particular direction. The term “transmit beam” may sometimes be used herein to refer to wireless signals that are transmitted in a particular direction whereas the term “receive beam” may sometimes be used herein to refer to wireless signals that are received from a particular direction.

If, for example, control circuitry 70 is adjusted to produce a first set of phases and/or magnitudes on the transmitted signals, the transmitted signals will form a millimeter or centimeter wave transmit beam as shown by beam 66 of FIG. 3 that is oriented in the direction of point A. If, however, control circuitry 70 adjusts phase and magnitude controllers 62 to produce a second set of phases and/or magnitudes on the transmitted signals, the transmitted signals will form a millimeter or centimeter wave transmit beam as shown by beam 68 that is oriented in the direction of point B. Similarly, if control circuitry 70 adjusts phase and magnitude controllers 62 to produce the first set of phases and/or magnitude, wireless signals (e.g., millimeter wave signals in a millimeter or centimeter wave beam) may be received from the direction of point A as shown by beam 66. If control circuitry 70 adjusts phase and magnitude controllers 62 to produce the second set of phases and/or magnitudes, signals may be received from the direction of point B, as shown by beam 68. Control circuit 70 may be controlled by control circuitry 14 of FIG. 2 or by other control and processing circuitry in device 10 if desired.

In one suitable arrangement, phase and magnitude controllers 62 may each include radio-frequency mixing circuitry. The phase and magnitude controllers may be referred to herein as controllers (e.g., controllers 62). Controllers 62 (e.g., mixing circuitry or mixers in controller 62) may receive signals from path 64 at a first input and may receive a corresponding signal weight value W at a second input (e.g., mixing circuitry in controller 62-1 may receive a first weight W₁, mixing circuitry in controller 62-2 may receive a second weight W₂, mixing circuitry in controller 62-N may receive an Nth weight W_{N}, etc.). Weight values W may, for example, be provided by control circuitry 14 (e.g., using corresponding control signals) or form other control circuitry. The mixer circuitry may mix (e.g., multiply) the signals received over path 64 by the corresponding signal weight value to produce an output signal that is transmitted on the corresponding antenna. For example, a signal S may be provided to phase controllers 62 over path 64. Mixing circuitry in controller 62-1 may output a first output signal S*W₁ that is transmitted on first antenna 40-1, mixing circuitry in controller 62-2 may output a second output signal S*W₂ that is transmitted on second antenna 40-2, etc. The output signals transmitted by each antenna may constructively and destructively interfere to generate a beam of signals in a particular direction (e.g., in a direction as shown by beam 66 or a direction as shown by beam 68). Similarly, adjusting weights W may allow for centimeter or millimeter wave signals to be received from a particular direction and provided to path 64. Different combinations of weights W provided to each mixer will steer the signal in different desired directions. If desired, control circuit 70 may actively adjust weights W provided to mixing circuitry in controllers 62 (and corresponding amplifier bias voltages) in real time to steer the transmit or receive beam in desired directions.

When performing millimeter wave communications, millimeter wave signals are conveyed over a line of sight path between phased antenna array 60 and external equipment. If the external equipment is located at location A of FIG. 3, circuit 70 may be adjusted to steer the signal beam towards direction A. If the external equipment is located at location B, circuit 70 may be adjusted to steer the signal beam towards direction B. In the example of FIG. 3, beam steering is shown as being performed over a single degree of freedom for the sake of simplicity (e.g., towards the left and right on the page of FIG. 3). However, in practice, the beam is steered over two degrees of freedom (e.g., into and out of the page and to the left and right on the page of FIG. 3).

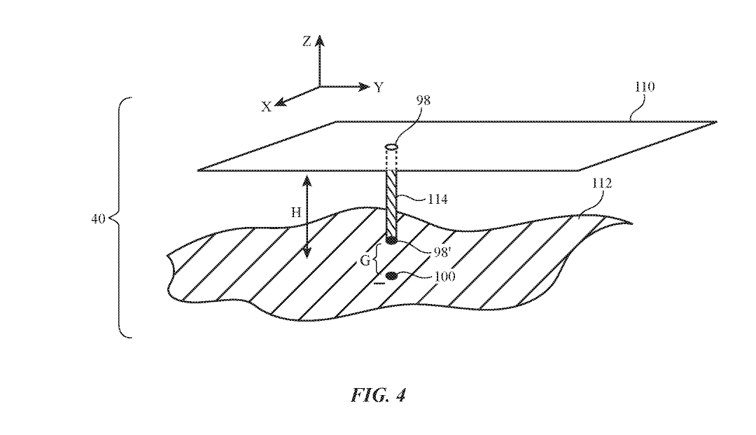

As previously described, patch antenna structures may be used for implementing antennas 40 (e.g., antennas on devices 10-1 and/or 10-2 of FIG. 1). An illustrative patch antenna that may be used in conveying wireless signals at frequencies between 10 GHz and 300 GHz or other wireless signals is shown in FIG. 4. As shown in FIG. 4, patch antenna 40 may have a patch antenna resonating element such as patch 110 that is separated from a ground plane structure such as ground 112. Patch 110 may be referred to herein as antenna patch resonating element 110, element 110, patch element 110, or resonating element 110. Antenna patch resonating element 110 and ground 112 may be formed from metal foil, machined metal structures, metal traces on a printed circuit or a molded plastic carrier, electronic device housing structures, or other conductive structures in an electronic device such as device 10-1 and/or 10-2.

Antenna patch resonating element 110 may lie within a plane such as the X-Y plane of FIG. 4. Ground 112 may lie within a plane that is parallel to the plane of antenna patch resonating element (patch) 110. Patch 110 and ground 112 may therefore lie in separate parallel planes that are separated by a distance H. Conductive path 114 may be used to couple terminal 98′ to terminal 98. Antenna 40 may be fed using a transmission line with a positive conductor coupled to terminal 98′ and thus terminal 98 and with a ground conductor coupled to terminal 100. Other feeding arrangements may be used if desired. Moreover, patch 110 and ground 112 may have different shapes and orientations (e.g., planar shapes, curved patch shapes, patch element shapes with non-rectangular outlines, shapes with straight edges such as squares, shapes with curved edges such as ovals and circles, shapes with combinations of curved and straight edges, etc.). Patch element 110 of antenna 40 may lie in a plane parallel to the X-Y plane of FIG. 4 and the surface of the structures that form a ground (i.e., ground 112) may lie in a parallel plane from the plane of element 110.

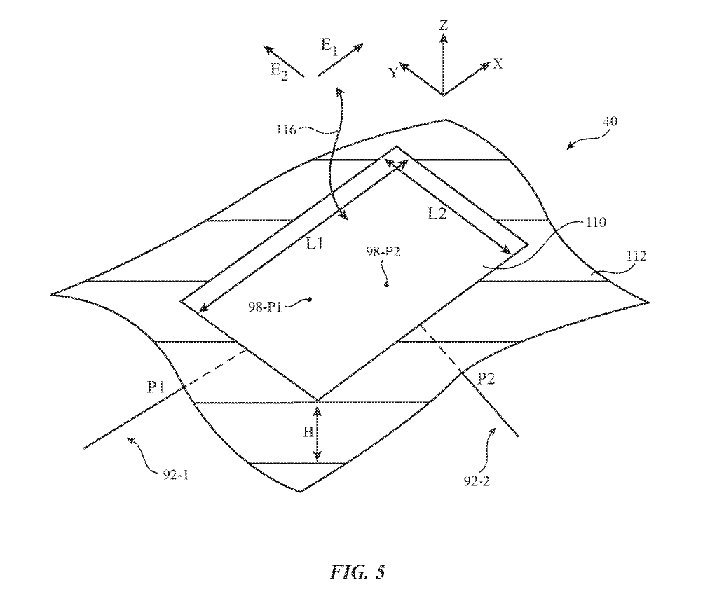

To enhance the frequency coverage and/or polarizations handled by patch antenna 40, antenna 40 may be provided with multiple feeds. An illustrative patch antenna with multiple feeds is shown in FIG. 5. As shown in FIG. 5, antenna 40 may have a first feed at antenna port P1 that is coupled to transmission line 92-1 and a second feed at antenna port P2 that is coupled to transmission line 92-2. The first antenna feed may have a first ground feed terminal coupled to ground 112 and a first positive feed terminal 98-P1 coupled to patch antenna resonating element 110. The second antenna feed may have a second ground feed terminal coupled to ground 112 and a second positive feed terminal 98-P2.

Patch 110 may have a rectangular shape with a pair of longer edges running parallel to dimension X and a pair of perpendicular shorter edges running parallel to dimension Y. The dimension of patch 110 in dimension X is L1 and the dimension of patch 110 in dimension Y is L2. With this configuration, antenna 40 may be characterized by orthogonal polarizations and multiple frequencies of operation.

When using the first antenna feed associated with port P1, antenna 40 may transmit and/or receive wireless radio-frequency signals in a first communications band at a first frequency (e.g., a frequency at which a half of a wavelength is equal to dimension L1). These signals may have a first polarization (e.g., the electric field E1 of radio-frequency signals 116 associated with port P1 may be oriented parallel to dimension X). When using the antenna feed associated with port P2, antenna 40 may transmit and/or receive radio-frequency signals in a second communications band at a second frequency (e.g., a frequency at which a half of a wavelength is equal to dimension L2). These signals may have a second polarization (e.g., the electric field E2 of radio-frequency signals 116 associated with port P2 may be oriented parallel to dimension Y so that the polarizations associated with ports P1 and P2 are orthogonal to each other). During wireless power transfer operations and/or wireless communications, device 10-1 and/or device 10-2 may use one or more antennas such as dual-polarization patch antenna 40 of FIG. 5 and may use port P1, port P2, or both port P1 and P2 of each of these antennas. When patch antenna 40 exhibits two orthogonal polarizations, it may be desirable to use an antenna formed from a pair of crossed dipoles (sometimes referred to as a crossed dipole antenna) on one end of path 106 and the patch antenna on the other end of path 106.

In scenarios in which patch 110 has different X and Y dimensions, antenna 40 will exhibit resonances at different frequencies (i.e., antenna 40 will serve as a dual-polarization dual-frequency patch antenna). Dual-polarization dual-frequency patch antennas, crossed dipoles, or other antennas may be used in multiple-antenna arrays (in device 10-1 and/or device 10-2). For example, device 10-1 and/or device 10-2 may have an array of antennas 40 that are used in a beam steering arrangement for wireless charging (e.g., wireless charging at 2.4 GHz or other microwave frequencies) or for wireless communications (e.g., millimeter wave communications at 60 GHz such as WiGig communications or communications at other suitable communications frequencies). Dual-polarization dual-frequency patch antennas may be used on one end of link 8 (e.g., on a receiving device, on a transmitting device in FIG. 1, etc.) or on both ends of link 8 (e.g., in device 10-1 and 10-2).

In the example of FIG. 5, patch element 110 has a rectangular shape with dimensions (length and width) L1 and L2. If desired, patch element 110 may be square (e.g., L1 and L2 may be equal so that patch 110 exhibits a resonance in a communications band at a single frequency) or may have other patch shapes (e.g., shapes with straight edges, curved edges, combinations of straight and curved edges, etc.).

In antenna 40 of FIG. 5 and other dual-port patch antennas, the first feed (i.e., the feed associated with first port P1) may be located along a central long axis of patch element 110 and the second feed (i.e., the feed associated with second port P2) may be located along a perpendicular central short axis of patch element 110. An optional shorting pin may be connected between ground 112 and patch 110 at a central point on patch 110 where the longer and shorter central axes of patch 110 intersect to help ensure that antenna impedance is minimized (i.e., near to zero) in the middle of antenna 40.

As examples, patch antennas such as the antennas described in FIGS. 4 and 5 may be arranged as a phased antenna array (e.g., phased antenna array 60 in FIG. 3). Phased antenna array 60 includes an array of antennas 40 (e.g., single-feed patch antennas, multi-feed patch antennas, any other type of antenna structure) formed on a dielectric substrate. The dielectric substrate may be a printed circuit board (e.g., a rigid or flexible printed circuit) or other dielectric material (e.g., foam, ceramic, glass, sapphire, plastic, a dielectric portion of housing 12, etc.). As an example, the antenna resonating elements (e.g., patch elements) of antennas 40 may be patterned onto a planar surface of the dielectric substrate. Array 60 may include any desired number of antennas 40 (e.g., two antennas 40, three antennas 40, four antennas 40, sixteen antennas 40, between four and sixteen antennas 40, more than sixteen antennas 40, etc.).

The beam of wireless millimeter wave signals transmitted or received by array 60 may be steered to point in a desired direction. As an example, array 60 may have an axis normal to the planar surface of array 40. By adjusting the phase and magnitude of settings of (e.g., by exhibiting different phase and magnitude settings in) controllers 62 (in FIG. 3), the beam may be steered by an azimuthal angle (e.g., an angle from 0 to 360 degrees) around the normal axis and by an inclination angle (e.g., an angle from −90 to 90 degrees) with respect to the normal axis. This example is merely illustrative and, in general, any desired coordinate system may be used to represent the direction in which the beam is steered.

As the phase and magnitude settings of phase controllers 62 are adjusted, the beam is steered to point in a desired direction (e.g., towards wireless communications equipment external to device 10-1 such as external device 10-2). Storage circuitry on device 10 may store phase settings (e.g., sets of phases to provide each controller 62) and corresponding amplifier settings (e.g., sets of magnitudes to provide each controller 62) to direct the beam in every possible or desired beam direction. The phase settings may, for example, be generated by calibrating device 10 (e.g., in a factory, manufacturing, or calibration system) over all possible angles to identify the phase and amplifier settings required to point the beam in any desired direction. Control circuitry 14 may retrieve the corresponding settings to use to point the beam in a selected direction during normal millimeter wave communications operations.

Different phase configurations may provide the beam with different levels of angular spread (in addition to pointing the beam in different directions). For a given transmit power level, the greater angular spread that is provided to the beam, the less the gain is for the beam (e.g., because the power of the millimeter wave signals is spread across a greater amount of area with respect to array 60). Similarly, the less angular spread that is provided to the beam, the more gain is provided for the beam.

Phased antenna array 60 may configure phase and magnitude controllers 62 to provide the beam with a relatively large angular spread and low gain or may configure controllers 62 to provide the beam with a relatively small angular spread and high gain. Similarly, adjusting the configuration of controllers 62 may also point the beam in different desired directions. Sectors may sometimes be used herein to describe the characteristics of millimeter wave beams that are transmitted or received by array 60 (e.g., in a particular direction, with a particular angular spread, and with a particular gain). In general, the sectors of array 60 may have any desired shape (e.g., a shape characteristic of the radiation pattern of array 60 under different phase controller settings). If desired, device 10 (e.g., devices 10-1 and/or 10-2) may include multiple arrays 60 located at different locations in device 10 to provide device 10 with a full sphere or hemisphere of antenna coverage around device 10.

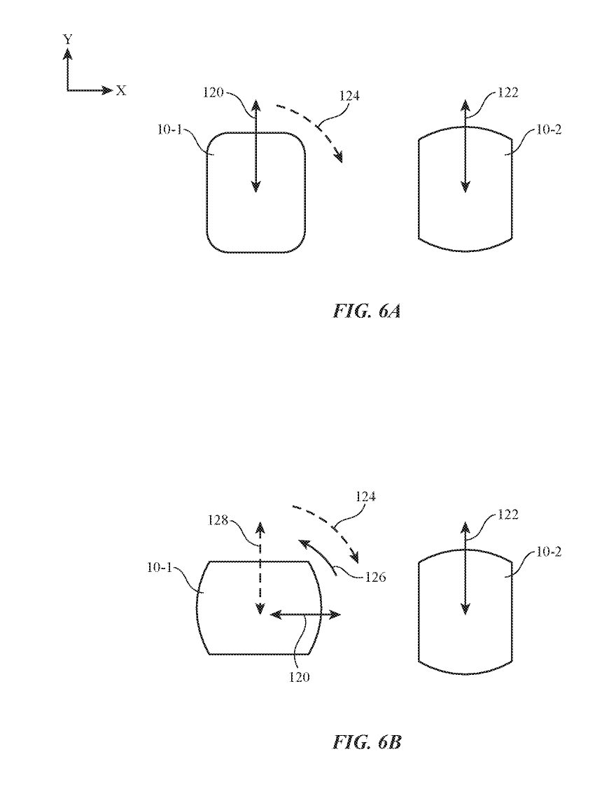

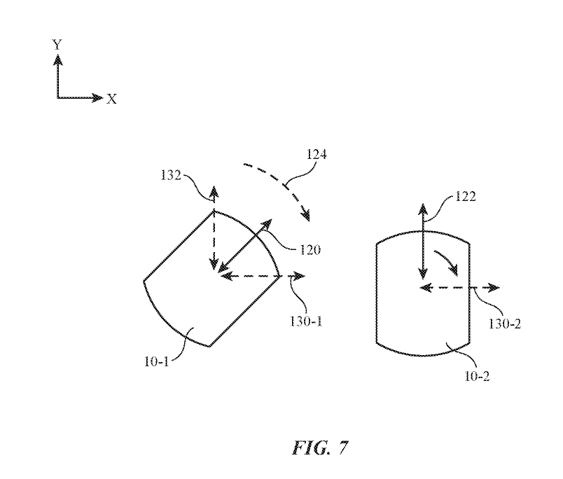

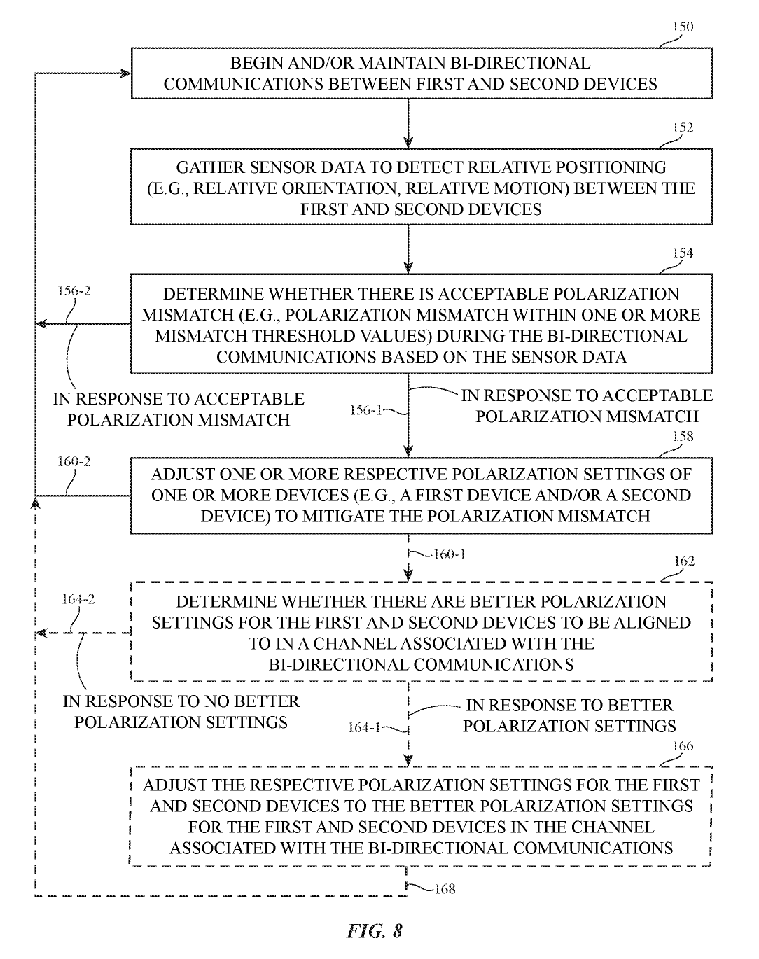

If desired, device 10 may include an array of single polarization antennas (e.g., single-feed patch elements). A first set of single-polarization antennas may be configured to generate radio-frequency signals with a first polarization, whereas a second set of single-polarization antennas may be configured to generate radio-frequency signals with a second polarization (e.g., a second polarization that is orthogonal to the first polarization). The first and second sets of single-polarization antennas may be rotated with respect to each other along the array. The array may additionally include other sets of single-polarization antennas configured to generate radio-frequency signals with other different polarizations. In these scenarios, different combinations of single-polarization antennas may be activated or deactivated (e.g., turned on or off using phase and magnitude adjustments) to change the polarization of a signal beam generated by the array as a whole (e.g., a combination antennas signals generated by the active antennas in the array). In such a way, an array with single polarization antennas may be configured to generate signal beams with differing polarizations (e.g., when performing the operations described in FIGS. 6A, 6B, 7, and the processing of FIG. 8).

Over time, device 10 may support an increasing number of data hungry applications and technologies having relatively high data throughput requirements. In order to support such applications and technologies having high data throughput requirements, device 10 may perform centimeter and/or millimeter wave communications using relatively high gain beams. When a first device (e.g., device 10-1 in FIG. 1) is communicating with a second device (e.g., device 10-2 in FIG. 1), a beam may be used to communicate with the first device with a relatively high data throughput (e.g., over a high data rate link such as millimeter wave link 8 of FIG. 1 having a data rate of 1 MBps or higher).

Additionally, the antennas or antenna arrays in devices 10-1 and/or device 10-2 used to establish link 8 may transmit and receive signals with particular polarizations that establish robust communications links (e.g., transmit and receive signals with the same polarization). In particular, to establish robust communications links, it may be desirable for an antenna in a transmitting device to transmit radio-frequency signals with a given polarization, and for an antenna in a receiving device to be configured to receive radio-frequency signals with the given polarization at all times, as this allows for essentially all data conveyed on the transmitting end to be received on the receiving end. In cases where the antenna on the receiving device is configured to receive radio-frequency signals that has a misaligned polarization from the given polarization (e.g., a polarization that is orthogonal to the given polarization), the receiving end may receive significantly less than all of the data conveyed on the transmitting end (e.g., essentially none of the data when the receiving polarization is orthogonal to the transmit polarization). This is sometimes referred to herein as polarization mismatch. Polarization mismatch may occur even when two communicative devices maintain their respective antenna signal polarization settings (e.g., continue to transmit and receive antenna signals with a given polarization). As an example, if the first device changes position and/or orientation (e.g., relative to second device 10-2), communications link 8 may be affected because of polarization mismatch between the transmit signal polarization for the transmitting device and receive signal polarization for the receiving device. If care is not taken, this may generate losses in the data conveyed between device 10 and the external device and/or the wireless connection may be dropped.

FIG. 6A shows an illustrative system having devices 10-1 and 10-2. Device 10-1 may include one or more antennas 40 that transmit and/or receive radio-frequency signals (e.g., centimeter wave signals, millimeter wave signals, EHF communications signals, wireless signals, etc.) having a polarization (e.g., a polarization as indicated by arrow 120). As shown in FIG. 6A, the polarization of signals transmitted by antennas 40 in device 10-1 as indicated by direction 120 (i.e., arrow 120) may be entirely in the Y direction (e.g., may have no component in the X direction). While the X-Y coordinate system is used herein, this is merely illustrative. In particular, the X coordinate may indicate a completely horizontal polarization, while a Y coordinate may indicate a completely vertical polarization. As an example, any other coordinate systems (e.g., polar, cylindrical, etc.) may be used to describe any type of polarization (e.g., circular polarization, elliptical polarization, planar polarization, etc.). As yet another example, a coordinate system relative to an orientation of a device (e.g., relatively to a length and width of an electronic device) may be used.

In device 10-1, which may include an antenna array, the polarization of the radio-frequency signals transmitted or received by device 10-1 may be a combination (e.g., a linear combination) of the individual polarizations of each of the one or more antennas 40 in the antenna array. Respective phase and magnitude controllers 62 (in control circuitry 14 or control circuit 70 as described in connection with FIG. 3) may control corresponding antennas 40 in array 60. Controllers 62 may exhibit different sets of phase and magnitude settings that contribute to different corresponding signal polarization settings for the corresponding antennas 40. In other words, the phase and magnitude settings of controller 62 for a given antenna may determine the polarization of the signals transmitted by the given antenna. As such, the phase and magnitude settings and any other desired settings that determine the polarization of transmit and receive signals (e.g., other settings of control circuit 70 in FIG. 3) may be referred in combination herein as an antenna signal polarization setting provided by control circuit 70.

To enhance communications for data hungry application and technologies, it may be desired to align the polarization of antennas 40 in antenna array 60 (e.g., provide each individual antenna with the same polarization settings). In this way, the entire antenna array may provide radio-frequency signals having the same polarization settings to maximize data throughput as across a communications link (e.g., data link 6 and data link 8 in FIG. 1).

Similarly, device 10-2 may include one or more antennas 40 that transmit and/or receive radio-frequency signals having a polarization (e.g., a polarization as indicated by arrow 122). As an example, device 10-2 may also include antennas 40 arranged in an antenna array (e.g., dual-polarization antennas in array 60 in FIG. 3, different sets of single polarization antennas in an array as previously described). In particular, antenna array 60 may be configured to transmit and/or receive radio-frequency signals having the polarization indicated by direction 122. In other words, control circuit 70 in device 10-2 may provide polarization settings to antennas 40 in array 60 configured to transmit and receive signals of a particular polarization setting. Because the polarization of signals generated by device 10-2 in direction 122 is entirely in the Y direction (e.g., has no component in the X direction), the polarization of transmit and receive radio-frequency signals for device 10-1 is the same as the polarization of transmit and receive radio-frequency signals for device 10-2. In other words, the polarization settings provided by respective control circuits 70 in devices 10-1 and 10-2 are the aligned (e.g., arrows 120 and 122 have the same directionality). As such, there is no polarization mismatch between devices 10-1 and 10-2 in FIG. 6A. In this scenario, device 10-1 receives all of the signals sent by device 10-2 and vice versa.

Over time, however, device 10-1 and/or device 10-2 may change orientations, positions, locations, etc. By changing the relative orientations, positions, and/or locations of communicative devices, the polarization of transmit and receive radio-frequency signals that were previously aligned may be misaligned. If desired, device 10-1 may include sensor circuitry that gathers sensor data regarding these changes in orientation, position, locations, etc. As described in connection to FIG. 2, device 10-1 may include control circuitry 14. In particular, control circuitry 14 may track the position and/or orientation of an external device (e.g., device 10-2) using sensor data generated by input-output devices 18 (e.g., sensor circuitry) on device 10-1. Control circuitry 14 may also track the position and/or orientation of the external device using sensor data received from the external device (e.g., from device 10-2). If desired, the sensor data generated by device 10-1 may be used in combination with the sensor data generated by the external device.

In general, control circuitry 14 may receive sensor data from any suitable source (e.g., sensor circuitry) to assist in tracking the position and/or orientation of the external device. As examples, light sensors, impedance sensors, wireless performance metric sensors, motion detectors, proximity sensors, magnetic sensors, optical cameras (e.g., image sensors), infrared cameras, etc. on device 10-1 may generate sensor data identifying the position and orientation of the external device relative to device 10-1 at any desired time interval. If desired, the position of the external device may be tracked continuously or in response to a stimulus (e.g., when tracking is enabled, when motion of the external device is detected, etc.). As an example, the external device may transmit location data (e.g., GPS data) and/or orientation data (e.g., gyroscope data) identifying the location and orientation of the external device to device 10-1 via a communication link such as non-millimeter wave link 6. As another example, sensor circuitry on device 10-1 such as wireless performance metric sensors may also generate signal polarization data, polarization mismatch data, any other signal property and metric data.

While device 10-1 may gather sensor data, this is merely illustrative. As previously described in connection FIG. 1, device 10-2 may be the same type of device as device 10-1. As such, device 10-2 may include control circuitry 14 and input output devices 18 (e.g., sensor circuitry) that enable device 10-2 to also gather sensor data. Device 10-2 may similarly perform sensor data gathering operations as described in connection with device 10-1 in addition to or instead of device 10-1 performing these functions.

As shown in FIG. 6B, device 10-1 may change orientations as indicated by dashed arrow 124 (e.g., from a vertical orientation to a horizontal orientation about a central point in device 10-1, rotate about a central axis normal to a planar surface of device 10-1). Sensor circuitry may generate sensor data that determines the type and extent of the movement of device 10-1. As examples, gyroscopes on device 10-1 may determine an orientation change in device 10-1, accelerometers on device 10-1 may determine the extent of the orientation change in device 10-1, etc.

If control circuit 70 in device 10-1 were to maintain the polarization settings associated with providing signals having a polarization indicated by direction 120, signals generated by device 10-1 would have polarizations entirely in the X direction (e.g., having no component in the Y direction). In this scenario, transmit and receive signals of antennas 40 in device 10-1 would have a polarization that is completely mismatched (e.g., perpendicular) to the polarization of transmit and receive signals of device 10-2 (i.e., arrows 120 and 122 in FIG. 6B are perpendicular to each other). As such, device 10-1 may receive none of the signals transmitted by device 10-2, and device 10-2 may receive none of the signals transmitted by device 10-1, resulting a dropped communications link.

The rotational movement of device 10-1 as shown in FIGS. 6A and 6B is merely illustrative. If desired, device 10-1 may also move locations relative to device 10-2 (e.g., move translationally, move laterally, move horizontally, move in any direction, move from a first surface to a second surface, etc.) in addition to or instead of changing orientations relative to device 10-2. The movement and orientation change may also cause polarization mismatch.

To mitigate polarization mismatch, device 10-1 may include antennas 40 that enable dual-polarization functionalities (e.g., dual-feed patch antennas of the type described in FIG. 5, different sets of single-feed antennas that collectively operate as a dual-polarization antenna array, etc.). In particular, as with antennas 40 described in FIG. 5, providing antennas signals to a first feed terminal (e.g., feed terminal 98-P2 in FIG. 5) may transmit signals of a first polarization (e.g., a polarization entirely along the Y direction as shown by direction 132 in FIG. 7) and providing antennas signals to a second feed terminal (e.g., feed terminal 98-P1 in FIG. 5) may transmit signals of a second polarization (e.g., a polarization entirely along the X direction as shown by direction 130-1 in FIG. 7). Additionally, providing a combination of antenna signals to the first and second feed terminals (e.g., providing signals to both ports 98-P1 and 98-P2 in FIG. 5) may transmit signals having a third polarization that is a combination of the first and second polarizations (e.g., a polarization that includes components in both the X and Y directions as shown by direction 120 in FIG. 7).

By adjusting the feed signals for antennas 40, device 10-1 may adjust the polarization settings of respective antennas (e.g., dual-fed patch antennas in array 60) in response to determining that device 10-1 has moved. In particular, sensor circuitry may determine that device 10-1 has moved and the properties of the movement (e.g., rotational, translational, magnitude of the movement, etc.). As an example, in response to determining that device 10-1 has moved, control circuitry on device 10-1 may adjust the polarization settings provided to the respective antennas by adjusting the phase settings, the amplifier settings, and/or other control circuit settings of control circuit 70 in device 10-1. As shown in FIG. 6B, control circuit 70 may adjust the polarization settings from a signal polarization associated with arrow 120 to a signal polarization associated with dashed arrow 128. The polarization of signals associated with arrow 128 may have a directionality entirely in a Y direction, which is aligned to the polarization of signals associated with arrow 122. Using the polarization settings associated with arrow 128, device 10-1 may transmit antennas signals that may be received by device 10-2 configured to receive radio-frequency signals having a polarization associated with arrow 122 and vice versa.

Additionally, a change in orientation for device 10-1 from the configuration of device 10-1 in FIG. 6A to the configuration of device 10-1 in FIG. 6B may not be instantaneous. In other words, as device 10-1 rotates, there will be increasing polarization mismatch, if device 10-1 maintains the polarization setting associated with arrow 120. For example, when device 10-1 is in an orientation where arrow 120 has a component both in the X and Y directions (e.g., as shown in FIG. 7), the Y component of arrow 120 for device 10-1 may be aligned with arrow 122 for device 10-2 and the X component of arrow 120 for device 10-1 may be misaligned or mismatched. In this case, only a portion of signals transmitted by device 10-1 (e.g., the portion of the signals associated with the Y component of arrow 120) is received by device 10-2. The partial polarization mismatch may worsen as device 10-1 changes configurations from that of FIG. 6A to that of FIG. 6B, ultimately reaching complete polarization mismatch.

To mitigate these issues associated with the transient orientations of device 10-1, control circuit 70 in device 10-1 may adjust the polarization setting of antennas in device 10-1 in real time (e.g., in response to detecting changes in orientation of device 10-1 with respect to device 10-2). If desired, as device 10-1 changes in orientation as indicated by arrow 124, control circuit 70 may adjust the polarization settings of antennas in device 10-1 gradually (e.g., correspondingly) as indicated by arrow 126. In this scenario, the signals transmitted and received by device 10-1 may continually have a polarization that is entirely in the Y direction such that the polarization of the signals are aligned with the polarization as indicated by arrow 122 in device 10-2.

Depending on the communications link requirements, device 10-1 may tolerate some acceptable amount of polarization mismatch. Accordingly, control circuitry 14 in device 10-1 may determine whether the polarization mismatch between the transmit and/or receive signals of respective devices 10-1 and 10-2 is acceptable. In particular, control circuitry 14 in device 10-1 may receive location data, orientation data, signal performance data, communications link data, signal polarization data, polarization mismatch data, or any other data to determine the extent of polarization mismatch. The extent of polarization mismatch may be compared to one or more threshold polarization mismatch values. As an example, the real-time polarization mismatch value may be compared to an upper threshold value (e.g., the maximum allowable polarization mismatch value). If the real-time polarization mismatch value is below the upper threshold value, control circuit 70 may continue to provide the current polarization setting to antennas 40 in device 10-1. Otherwise, control circuit 70 may adjust the polarization setting to better match the polarization of the transmitting and/or receiving device (e.g., device 10-2).

As an example, FIG. 7 shows an illustrative system having device 10-1 in a transient configuration (e.g., an orientation that device 10-1 passes when rotating from the orientation shown in FIG. 6A to the orientation shown in FIG. 6B). In particular, in the transient configuration, control circuit 70 in device 10-1 may maintain a polarization setting that configures antennas 40 on device 10-1 to transmit and receive signals with a polarization associated with direction 120. However, by using the polarization settings associated with direction 120, device 10-1 may have a partial polarization mismatch with device 10-2, which is configured to transmit and receive signals with polarizations associated with direction 122. For example, device 10-1 may only receive half, a third, a quarter, etc. of signals sent from device 10-2 and vice versa.

Therefore, device 10-1 may use control circuit 70 to adjust the polarization settings provided to corresponding antennas (e.g., antennas 40-1 to 40-N in array 60 as shown in FIG. 3) such that the cumulative polarization is aligned with arrow 132. Similar to FIG. 6B, the adjusted polarization associated with device 10-1 (e.g., polarization direction 128 in FIG. 6B and polarization direction 132 in FIG. 7) may be the same as the polarization direction associated with device 10-2 (e.g., polarization direction 122 with which device 10-2 transmits and receives signals).

If desired, devices 10-1 and 10-2 may both be devices that have dual-polarization signal transmission capabilities. For example, device 10-2 may also include an array of dual-feed patch antennas (as described in connection with FIG. 5) that each have two feeds corresponding to two particular polarization directions. The two feeds may additionally be used in combination to cover any other polarization directions.

In the scenario where both devices 10-1 and 10-2 include antennas having dual-polarization functionalities, devices 10-1 and 10-2 may also find the best polarization direction for a particular communications channel (e.g., frequency, frequency band, etc.). As an example, while device 10-1 in FIG. 7 may adjust antennas 40 in device 10-1 to transmit and receive signals with a polarization associated with direction 132 to align with the transmit and receive signals of device 10 having a polarization associated with direction 122, devices 10-1 and device 10-2 may communicate using a more efficient polarization setting (e.g., polarization setting associated with direction 130). As an example, the increased efficiency of communications using polarization direction 130 may be associated with less noise, higher data transfer rate, lower data loss, etc. In particular, when communicating at a particular frequency or channel, devices 10-1 and 10-2 may communicate at frequencies each having a particular efficient polarization.

In other words, one of devices 10-1 or 10-2 may determine that a more efficient polarization direction exists. As an example, sensor data gather by sensor circuitry on a device may discover a more efficient polarization direction (e.g., directions 130-1 and 130-2) to use for communications link 8 between devices 10-1 and 10-2. Devices 10-1 and 10-2 may therefore adjust their respective control circuits 70 to change the polarization settings associated with their respective antennas to align with directions 130-1 and 130-2, respectively.

FIG. 8 is an illustrative flowchart for operating one or more devices (e.g., devices 10-1 and 10-2) to mitigate polarization mismatch and to configure the one or more devices to align to an optimal polarization direction. At step 150, first and second devices 10-1 and 10-2 may establish and maintain a bi-directional communications link (e.g., communications link 8 of FIG. 1). If desired, devices 10-1 and 10-2 may also begin and maintain unidirectional links or other communications links instead of or in addition to link 8 (e.g., communications link 6 in FIG. 1). For example, as described in connection with FIG. 6A, device 10-1 may be configured to transmit signals of a given polarization to device 10-2, and device 10-2 may be configured to transmit signals of a given polarization to device 10-1.

At step 152, device 10-1 may use control circuitry 14 to gather sensor data for detecting the relative position (e.g., relative orientation, relative motion, relative location) between devices 10-1 and 10-2. For example, control circuitry 14 in device 10-1 may receive location data for device 10-2 relative to device 10-1 from sensor circuitry (e.g., a GPS sensor) on one or both of devices 10-1 and 10-2 in real time. As another example, control circuitry 14 in device 10-1 may receive orientation data for device 10-2 relative to device 10-1 from sensor circuitry (e.g., a gyroscope) on one or both of devices 10-1 and 10-2. These examples are merely illustrative. As described in connection with FIGS. 2, 6A, and 6B, control circuitry 14 in devices 10-1 and/or 10-2 may also gather other sensor data using sensor circuitry (e.g., signal polarization data and/or polarization mismatch data using wireless performance metric sensors).

At step 154, control circuitry 14 in device 10-1 may determine whether there is polarization mismatch during the bi-directional communications based on the gather sensor data. More specifically, control circuitry 14 in device 10-1 may determine whether the amount of polarization mismatch is acceptable (e.g., whether the polarization mismatch is within a threshold range, or lower than a ceiling threshold value). As an example, when device 10-1 changes from the configuration shown in FIG. 6A to the configuration shown in FIG. 6B, device 10-1 may generate sensor data (e.g., orientation data) that may be used to determine the polarization of signals transmitted by antennas 40 on device 10-1. In particular, control circuitry 14 may determine using the generated sensor data that the polarization of signals (e.g., as indicated by arrow 120) is now perpendicular to the polarization of the receive signals (e.g., as indicated by arrow 122) for antennas 40 on device 10-2.

As another example, device 10-1 may generate signal performance metric data that determine the relative polarization between the respective transmit and receive signals of devices 10-1 and 10-2. Similarly, device 10-2 may also generate analogous signal performance metric data that may be provided to device 10-1 (e.g., via communications link 6). A predetermined range of acceptable performance metric values may be defined by one or more wireless performance metric threshold values (e.g., the range of acceptable performance metric values may be less than a maximum performance metric threshold value and/or greater than a minimum performance metric threshold value). The predetermined range of acceptable values need not have both maximum and minimum threshold values. For example, the predetermined range of acceptable values may include any packet error rate values less than a maximum threshold packet error rate value, any receive power level value greater than a minimum receive power level value, etc. These examples are merely illustrative. If desired, any suitable sensor data may be used to determine an amount of polarization mismatch and whether the amount of polarization mismatch is tolerable.

In response to determining that there is an acceptable amount of polarization mismatch, processing may proceed via path 156-2. For example, control circuitry 70 may compare the current level of polarization mismatch (e.g., defined by a current packet error rate value obtained using sensor circuitry) with a threshold of acceptable polarization mismatch values (e.g., a predetermined range of acceptable values that include any packet error rate value less than a maximum threshold packet error rate value). If the current packet error rate value is within (e.g., below) the maximum threshold packet error rate value, processing may proceed via path 156-2.

Device 10-1 may therefore proceed to maintain the bi-directional communications link with device 10-2 by having control circuit 70 maintain the current polarization settings for antennas 40 on device 10-1. As an example, to enhance signal communications performance, device 10-1 may be unable to tolerate any amount of polarization mismatch (e.g., the range of acceptable performance metric values may have a maximum allowable threshold packet error rate value that is essentially zero percent). In this scenario, in response to detecting any amount of polarization mismatch (e.g., a current packet error rate value above zero percent), processing may proceed via path 156-1 to step 158.

At step 158, control circuitry 70 in device 10-1 may adjust polarization settings for antennas 40 on device 10-1, and optionally, control circuitry in device 10-2 may also adjust polarization settings for antennas 40 on device 10-2. In particular, respective control circuits 70 may adjust the polarization settings on respective devices 10-1 and 10-2 such that respective transmit and receive signals of devices 10-1 and 10-2 have the same polarization to mitigate polarization mismatch. As an example, control circuit 70 on device 10-1 in FIG. 6B may adjust the polarization settings provided to antennas 40 such that signals generated by antennas 40 in device 10-1 may provide polarization aligned with direction 128 instead of direction 120. Therefore, the polarization of the transmit and receive signals for device 10-1 (in direction 128) may be the same as the polarization of the transmit and receive signals for device 10-2 (in direction 122). If desired, device 10-2 may similarly align the polarization of its transmit and receive signals to that of the transmit and receive signals for device 10-1.

After implementing the adjusted polarization settings, control circuit 70 on device 10-1 may subsequently proceed by looping back to step 150 via path 160-2, and devices 10-1 and 10-2 may maintain the bi-directional communications link using the current (adjusted) settings. If desired, control circuitry on device 10-1 may cyclically process steps 150, 152, and 154 continuously, at any desired time interval, at any frequency, in response to any stimulus, etc.

After processing step 158, control circuitry 14 on device 10-1 may optionally process step 162 by proceeding on path 160-1. At step 162, control circuitry 14 on device 10-1 may determine whether there are better polarization settings to provide to antennas on devices 10-1 and 10-2 that may enhance performance in the bi-directional communications channel. Alternatively, or additionally, control circuitry 14 devices 10-2 may also determine whether better polarization settings for devices 10-1 and 10-2 exist. Better polarization settings may increase or maximize the efficiency of communications link 8 (e.g., increase throughput, minimize data loss, support higher frequency operations, etc.)

Sensor circuitry may similarly generate sensor data that may be used to determine whether there are more efficient polarization settings for devices 10-1 and 10-2 to implement. For example, although the polarization of respective signals transmitted and received by devices 10-1 and 10-2 may be the same, devices 10-1 and 10-2 may still communicate sensor data with each other (e.g., via link 6) that may be used to determine a more efficient signal polarization that devices 10-1 and 10-2 may both use. In particular, as shown in FIG. 7, while devices 10-1 and 10-2 implement polarization settings associated with polarization directions 132 and 122, respectively, devices 10-1 and 10-2 may continue to search for more efficient channel polarizations to which respective radio-frequency signals can be aligned.

In response to determining that there are no better polarization settings the current polarization settings provided to respective antennas on devices 10-1 and 10-2, control circuit 70 on device 10-1 may subsequently proceed by looping back to step 150 via path 164-2, and devices 10-1 and 10-2 may maintain the bi-directional communications link using the current settings.

In response to determining that there is at least one better polarization setting that respective control circuits 70 on devices 10-1 and 10-2 may implement, processing may proceed via path 164-1 to step 166. At step 166, respective control circuitry (e.g., respective control circuits 70) on devices 10-1 and 10-2 may simultaneously adjust respective polarization settings to implement the better polarization setting in the bi-directional communications channel. As an example, devices 10-1 and device 10-2 may adjust respective control circuits 70 to generate antenna signals associated with polarization directions 130-1 and 130-2 respectively.

After processing step 166, control circuitry on device 10-1 may loop back to step 150 to maintain the bi-directional communications link using the adjusted (new) polarization settings for devices 10-1. Control circuitry on device 10-2 may similarly use the adjusted polarization setting to maintain the bi-directional link.

As an example, control circuitry 14 in device 10-1 may process steps 150 to 166 continuously or at any time interval (e.g., every second, every millisecond, every minute, etc.). If desired, certain steps in FIG. 8 may be omitted. As an example, if only the first device includes dual-polarization functionalities, steps 162 and 166 may be omitted, as only the first device may adjust its polarization settings to mitigate polarization mismatch. As another example, step 158 may be omitted to enable devices 10-1 and 10-2 to directly determine whether there are better polarization settings that would require both devices to change their respective polarization settings.

While the examples provided in FIGS. 6-8 describe device 10-1 changing orientations, locations, positions, etc., and processing these changes. This is merely illustrative. If desired, device 10-2 may also change orientations, locations, positions, etc., over time, and device 10-2 may similar process these changes to mitigate polarization mismatch and generate better channel polarizations for the communications link. If desired, when devices 10-1 and/or 10-2 moves, any device (e.g., devices 10-1 and/or 10-2) may generate sensor data in real-time to mitigate polarization mismatch between any two communicating devices. Additionally, while FIGS. 6-8 refer to phased antenna arrays as examples, this is merely illustrative. If desired, any types of any other type of antenna structures (e.g., dual-feed antennas, multi-polarization setting enabled antennas, antenna structures described in connection with FIG. 2, etc.) may be used within devices 10-1 and 10-2 to perform polarization mismatch loss mitigation operations as described in connection with FIGS. 6-8.

Control circuitry 14 and control circuit 70 on devices 10-1 and 10-2 may be configured to perform these operations (e.g., the operations of FIGS. 6-8) using hardware (e.g., dedicated hardware or circuitry) and/or software (e.g., code that runs on the hardware of device 10). Software code for performing these operations is stored on non-transitory computer readable storage media (e.g., tangible computer readable storage media). The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, other computer readable media, or combinations of these computer readable media or other storage. Software stored on the non-transitory computer readable storage media may be executed on the processing circuitry of control circuitry 14. The processing circuitry may include application-specific integrated circuits with processing circuitry, one or more microprocessors, or other processing circuitry.

The foregoing is merely illustrative and various modifications can be made to the described embodiments. The foregoing embodiments may be implemented individually or in any combination.

1. An electronic device configured to wirelessly communicate with an external device, the electronic device comprising:
an antenna configured to transmit wireless signals at a first polarization;
sensor circuitry that generates sensor data; and
control circuitry coupled to the sensor circuitry, wherein the control circuitry is configured to identify a second polarization that is different from the first polarization based on the generated sensor data and to control the antenna to transmit the wireless signals at the second polarization.

2. The electronic device defined in claim 1, wherein the control circuitry is configured to compare the generated sensor data to a predetermined range of sensor values and to control the antenna to transmit the wireless signals at the second polarization in response to identifying that the sensor data is outside of the predetermined range of sensor values.

3. The electronic device defined in claim 1, wherein the sensor circuitry comprises an orientation sensor and the generated sensor data comprises orientation data indicative of an orientation of the electronic device.

4. The electronic device defined in claim 1, wherein the control circuitry is configured to:
gather wireless performance metric data associated with the wireless signals at the first polarization;
compare the gathered wireless performance metric data to a predetermined range of performance metric data values; and
control the antenna to transmit the wireless signals at the second polarization in response to determining that the gathered wireless performance metric data is outside of the predetermined range of wireless performance metric data values.

5. The electronic device defined in claim 1, wherein the antenna comprises an antenna resonating element having an antenna feed, the electronic device further comprising:
a phase and magnitude controller coupled to the antenna feed, wherein the phase and magnitude controller is configured to exhibit a first set of phase and magnitude settings while the antenna is configured to transmit the wireless signals at the first polarization.

6. The electronic device defined in claim 5, wherein the antenna resonating element includes an additional antenna feed, the electronic device further comprising:
an additional phase and magnitude controller coupled to the additional antenna feed, wherein the additional phase and magnitude controller is configured to exhibit a second set of phase and magnitude settings while the antenna is configured to transmit the wireless signals at the first polarization.

7. The electronic device defined in claim 6, wherein phase and magnitude controller is configured to exhibit a third set of phase and magnitude settings that is different from the first set of phase and magnitude settings while the antenna transmits the wireless signals at the second polarization.

8. The electronic device defined in claim 5, wherein the antenna comprises an additional antenna resonating element having an additional antenna feed, the electronic device further comprising:
an additional phase and magnitude controller coupled to the additional antenna feed, wherein the control circuitry is configured to control the phase and magnitude controller and the additional phase and magnitude controller to steer the transmitted wireless signals towards the external device.

9. The electronic device defined in claim 1, wherein the transmitted signals comprise millimeter wave signals.

10. An electronic device configured to wirelessly communicate with external equipment, the electronic device comprising:
a phased antenna array configured to convey wireless signals at a frequency greater than 10 GHz; and
control circuitry coupled to the phased antenna array, wherein the control circuitry is configured to identify a polarization mismatch between the phased antenna array and the external equipment and to adjust a polarization of the phased antenna array based on the identified polarization mismatch.

11. The electronic device defined in claim 10, the electronic device further comprising:
sensor circuitry that generates sensor data, wherein the control circuitry is configured to identify the polarization mismatch by comparing the generated sensor data to predetermined range of sensor data values.

12. The electronic device defined in claim 11, wherein the control circuitry is configured to maintain the polarization of the phased antenna in response to determining that the generated sensor data is within the predetermined range of sensor data values.

13. The electronic device defined in claim 12, wherein the phased antenna array comprises a plurality of antennas and a respective phase and magnitude controller coupled to each antenna in the plurality of antennas, and the control circuitry is configured to adjust the polarization of the phased antenna array by adjusting phase and magnitude settings of the phase and magnitude controllers in the phased antenna array.

14. The electronic device defined in claim 10, wherein the phased antenna array comprises a plurality of antennas each having an antenna feed, and a first subset of antennas in the plurality of antennas is configured to convey signals having a first polarization.

15. The electronic device defined in claim 14, wherein a second subset of antennas in the plurality of antennas is configured to convey signals having a second polarization that is different than the first polarization.

16. A method of operating an electronic device to communicate with an external device, wherein the electronic device includes a phased antenna array and control circuitry coupled to the phased antenna array, the method comprising:
with the phased antenna array, transmitting wireless signals at a frequency greater than 10 GHz using a signal polarization setting;
with the control circuitry, identifying a difference in orientation between the electronic device and the external device; and
with the control circuitry, adjusting the signal polarization setting based on the identified difference in orientation between the electronic device and the external device.

17. The method defined in claim 16, wherein identifying the difference in orientation comprises:
with sensor circuitry, generating orientation data for the electronic device;
with the control circuitry, receiving the generated orientation data for the electronic device; and
with the control circuitry, processing the orientation data for the electronic device and orientation data for the external device to generate the difference in orientation between the electronic device and the external device.

18. The method defined in claim 17, wherein the sensor circuitry comprises an accelerometer.

19. The method defined in claim 17, further comprising:
with the control circuitry, receiving the orientation data for the external device by receiving wireless signals at a frequency less than 10 GHz at the electronic device.

20. The method defined in claim 17, wherein the sensor circuitry comprises an image sensor, the method further comprising:
with the image sensor, generating the orientation data for the external device.
